(19) United States
(12) Patent Application Publication
(10) Pub. No.: US 2026/0086482 A1
(43) Pub. Date: Mar. 26, 2026

(54) BELT UNIT AND IMAGE FORMING APPARATUS

(71) Applicant: FUJIFILM Business Innovation Corp., Tokyo (JP)

(72) Inventors: Takuma ISHIHARA, Kanagawa (JP); Takashi MATSUBARA, Kanagawa (JP); Takashi OHASHI, Kanagawa (JP); Motoharu NAKAO, Kanagawa (JP); Hina SAITO, Kanagawa (JP)

(73) Assignee: FUJIFILM Business Innovation Corp., Tokyo (JP)

(21) Appl. No.: 19/017,746

(22) Filed: Jan. 12, 2025

(30) Foreign Application Priority Data
Sep. 24, 2024 (JP) 2024-164834

(51) Int. Cl. G03G 15/00; G03G 15/20

(52) U.S. Cl. CPC G03G 15/50; G03G 15/2053; G03G 15/2064

(57) ABSTRACT

A belt unit includes an endless member that is rotated, a support member that supports the endless member, a counter member that is disposed to face the support member with the endless member interposed therebetween and is in contact with the endless member at a predetermined first contact pressure, a heating section that heats the endless member, and a control unit that starts heating in the heating section in a case where rotation of the endless member is started, and controls at least one of the support member or the counter member to control a contact pressure between the endless member and the counter member to a second contact pressure higher than the first contact pressure.

### CROSS-REFERENCE TO RELATED APPLICATIONS

This application is based on and claims priority under 35 USC 119 from Japanese Patent Application No. 2024-164834 filed Sep. 24, 2024.

### BACKGROUND

### (i) Technical Field

The present invention relates to a belt unit and an image forming apparatus.

### (ii) Related Art

Techniques disclosed in JP2008-165102A, JP2009-069220A, and JP2001-075385A to be described below are publicly known with regard to a fixing device that heats and fixes an unfixed image on the surface of a medium in an image forming apparatus.

JP2008-165102A (Paragraphs [0008] to [0010], [0056] to [0074], and FIGS. 2 to 4) discloses a fixing device that includes a heating roller (10) and a pressure belt (20). In a configuration disclosed in JP2008-165102A, grip portions (G1) having a high friction coefficient are provided on the inner side of the pressure belt (20) outside a sheet feed range of a pressing member (5). When the heating roller (10) starts to rotate, the pressure belt (20) is reliably driven with the high friction coefficient of the grip portion (G1).

JP2009-069220A (Paragraphs [0008] to [0014], [0064] to [0085], FIG. 3 and FIGS. 5 to 7) discloses a fixing device that includes a fixing roller (60) and a pressure roller (70). In JP2009-069220A, an endless belt (83) is in contact with the fixing roller (60) and is heated in a state where the endless belt (83) is stretched by heater lamps (86, 87). The endless belt (83) changes tension before fixing to relieve a pattern (a tendency to be wound) of the endless belt (83) and to suppress the poor rotation of the endless belt (83).

JP2001-075385A (Paragraphs [0014] to [0016] and FIG. 2) discloses a fixing device that includes a fixing belt (110) and a pressure roller (120). In JP2001-075385A, high grip members (G) are fixed to both end portions of the outer periphery of the fixing belt (110) in a width direction. The high grip members (G) are adapted to absorb oil applied to the surface of the fixing belt (110) or to allow the oil to flow in a circumferential direction. Since the high grip members (G) are provided, a grip force between the fixing belt (110) and the pressure roller (120) is ensured.

### SUMMARY

Aspects of non-limiting embodiments of the present disclosure relate to a belt unit and an image forming apparatus that suppress damage to an endless member as compared to a case where the endless member starts to rotate at a contact pressure identical to a contact pressure during use.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a belt unit including: an endless member that is rotated; a support member that supports the endless member; a counter member that is disposed to face the support member with the endless member interposed therebetween and is in contact with the endless member at a predetermined first contact pressure; a heating section that heats the endless member; and a control unit that starts heating in the heating section in a case where rotation of the endless member is started, and controls at least one of the support member or the counter member to control a contact pressure between the endless member and the counter member to a second contact pressure higher than the first contact pressure.

### BRIEF DESCRIPTION OF THE DRAWINGS

Exemplary embodiment(s) of the present invention will be described in detail based on the following figures, wherein:

FIG. 1 is an overall view of an image forming apparatus according to Example 1 of the present invention;

FIGS. 2A and 2B are enlarged views of a fixing device of Example 1 in which FIG. 2A is a diagram showing a state where a support member is moved to a first contact position and FIG. 2B is a diagram showing a state where the support member is moved to a second contact position; and

FIG. 3 is a functional block diagram of a controller of Example 1.

### DETAILED DESCRIPTION

Examples as specific examples of an exemplary embodiment of the present invention will be described below with reference to the drawings, but the present invention is not limited to Examples to be described below.

In order to facilitate the understanding of the following description, in the drawings, a front-rear direction will be referred to as an X-axis direction, a right-left direction will be referred to as a Y-axis direction, and a vertical direction will be referred to as a Z-axis direction. Directions or sides indicated by arrows X, −X, Y, −Y, Z, and −Z will be defined as a forward direction, a rearward direction, a rightward direction, a leftward direction, an upward direction, and a downward direction, or a front side, a rear side, a right side, a left side, an upper side, and a lower side, respectively.

Further, in the drawings, a symbol “∘” with a symbol “·” therein means an arrow from the back of the plane of the sheet to the front thereof and a symbol “∘” with a symbol “x” therein means an arrow from the front of the plane of the sheet to the back thereof.

In the following description using the drawings, members other than members required for description will be appropriately omitted to facilitate understanding.

### Example 1

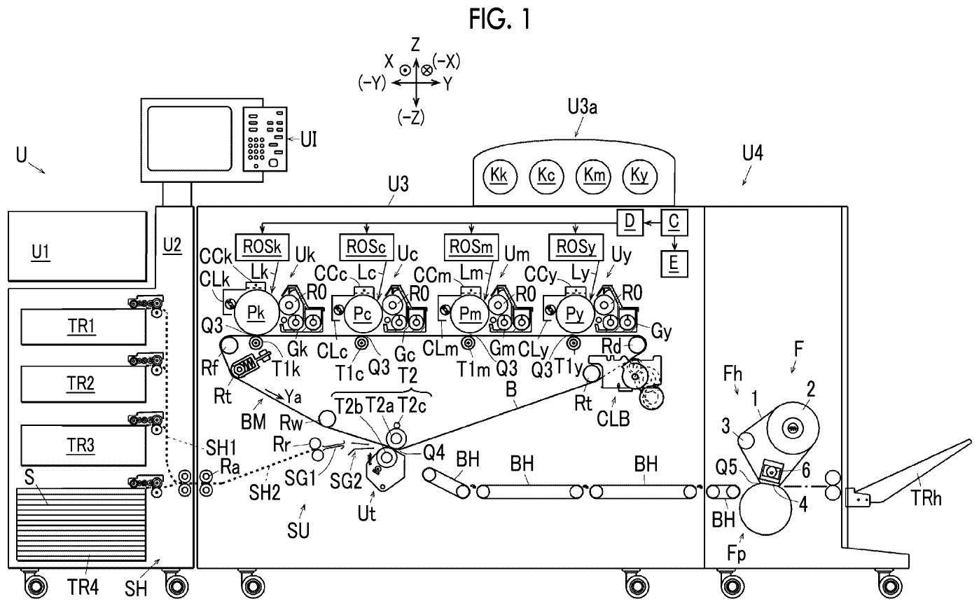

FIG. 1 is an overall view of an image forming apparatus according to Example 1 of the present invention.

In FIG. 1, a copying machine U as an example of an image forming apparatus includes a user interface UI as an example of an operation section, a scanner device U1 as an example of an image reading device, a sheet feed device U2, a printer unit U3 as an example of an image recording section, and a sheet discharge unit U4.

The user interface UI includes a power button or a copy start key, a number-of-copies setting key, a numeric keypad, and the like as an example of an input unit; a display unit; and the like.

The scanner device U1 reads an original document (not shown), converts read data into image information, and inputs the image information to the printer unit U3.

The sheet feed device U2 includes a plurality of sheet feed trays TR1, TR2, TR3, and TR4 as an example of a sheet feed unit. Recording sheets S as an example of mediums are stored in each of the sheet feed trays TR1 to TR4. A sheet feed passage SH1 as an example of a transport passage for a medium extends from each of the sheet feed trays TR1 to TR4 toward the printer unit U3.

In FIG. 1, the printer unit U3 includes a controller C as an example of a control unit, a power source circuit E that supplies power to each member of the printer unit U3, and the like. The controller C receives the image information of the original document read by the scanner device U1 and image information transmitted from a personal computer as an example of an information transmission device (not shown) connected to the copying machine U.

The controller C processes the received image information into printing information for Y (yellow), M (magenta), C (cyan), and K (black), and outputs the processed information to a laser drive circuit D as an example of a drive circuit of a latent image writing device. The laser drive circuit D outputs a laser drive signal, which is input from the controller C, to exposure devices ROSy, ROSm, ROSc, and ROSk as an example of latent image forming sections for the respective colors at preset times.

Image holder units Uy, Um, Uc, and Uk for Y, M, C, and K are disposed below the respective exposure devices ROSy to ROSk.

In FIG. 1, the image holder unit Uk for K (black) includes a photoreceptor drum Pk as an example of an image holding member, a charging corotron CCk as an example of a charging section, and a photoreceptor cleaner CLK as an example of a cleaning section for the image holding member. Further, the image holder units Uy, Um, and Uc for the other colors Y, M, and C also include photoreceptor drums Py, Pm, and Pc, charging corotrons CCy, CCm, and CCc, and photoreceptor cleaners CLy, CLm, and CLc.

Furthermore, in Example 1, the photoreceptor drum Pk for the K color of which the frequency of use is high and the surface is to be more worn is formed to have a larger diameter than the photoreceptor drums Py, Pm, and Pc for the other colors, so that high-speed rotation and a long service life are achieved.

After the photoreceptor drums Py to Pk are uniformly charged by the charging corotrons CCy to CCk, respectively, electrostatic latent images are formed on the surfaces of the photoreceptor drums Py to Pk by laser beams Ly, Lm, Lc, and Lk as an example of latent image writing light output from the exposure devices ROSy to ROSK. The electrostatic latent images formed on the surfaces of the photoreceptor drums Py to Pk are developed into toner images having the respective colors, that is, Y (yellow), M (magenta), C (cyan), and K (black) by developing devices Gy, Gm, Gc, and Gk as an example of developing sections.

The toner images formed on the surfaces of the photoreceptor drums Py to Pk are sequentially and overlappingly transferred onto an intermediate transfer belt B, which is an example of an intermediate transfer section and an example of an image holding member, in primary transfer regions Q3 by primary transfer rollers T1y, T1m, T1c, and T1k as an example of primary transfer sections, so that a multicolor image, that is, a so-called color image is formed on the intermediate transfer belt B. The color image formed on the intermediate transfer belt B is transported to a secondary transfer region Q4.

Further, in the case of only black image data, only the photoreceptor drum Pk for K (black) and the developing device Gk are used and only a black toner image is formed.

After the primary transfer, residual toner remaining on the surfaces of the photoreceptor drums Py to Pk is cleaned off by the photoreceptor cleaners CLy to CLk.

Each of the image holder units Uy to Uk and each of the developing devices Gy to Gk form a toner image forming member as an example of an image forming section.

A toner dispenser U3a as an example of a replenishment section is disposed on an upper portion of the printer unit U3, and toner cartridges Ky, Km, Kc, and Kk as an example of developer storage sections are attachably and detachably mounted on the toner dispenser U3a. In a case where toner is consumed in the developing devices Gy to Gk as images are formed, toner is supplied to each of the developing devices Gy to Gk from each of the toner cartridges Ky to Kk.

The intermediate transfer belt B disposed below the photoreceptor drums Py to Pk is stretched by an intermediate drive roller Rd as an example of a drive section for the intermediate transfer section, an intermediate tension roller Rt an example of a tension application member that applies tension to the intermediate transfer belt B, an intermediate steering roller Rw as an example of a first bias correction section that corrects bias or meandering of the intermediate transfer belt B, a plurality of intermediate idler rollers Rf as an example of driven sections, and a backup roller T2a as an example of a counter member in a secondary transfer region. Further, the intermediate transfer belt B is supported to be rotatable and movable in a direction of an arrow Ya by being driven by the intermediate drive roller Rd.

The intermediate drive roller Rd, the intermediate tension roller Rt, the intermediate steering roller Rw, the intermediate idler rollers Rf, the backup roller T2a, the primary transfer rollers T1y to T1k, the intermediate transfer belt B, and the like form a belt module BM as an example of an intermediate transfer device. Furthermore, the belt module BM of Example 1 is formed of a unit that is attachable to and detachable from the printer unit U3 or is replaceable in the printer unit U3.

A secondary transfer unit Ut as an example of a transfer/transport unit is disposed below the backup roller T2a. The secondary transfer unit Ut includes a secondary transfer roller T2b as an example of a transfer member. The secondary transfer roller T2b is disposed to face the backup roller T2a. The secondary transfer region Q4 is formed of a region where the secondary transfer roller T2b faces the intermediate transfer belt B. Further, a contact roller T2c as an example of a contact section, which is used to apply a voltage, is in contact with the backup roller T2a. A secondary transfer voltage having a polarity identical to the charging polarity of the toner is applied to the contact roller T2c from the power source circuit E controlled by the controller C at a preset time.

A secondary transfer device T2 as an example of a secondary transfer section is formed of the respective rollers T2a to T2c. Furthermore, a transfer device B+T1+T2 as an example of a transfer section is formed of the intermediate transfer belt B, the primary transfer rollers T1y to T1k, the secondary transfer device T2, and the like.

A sheet transport passage SH2 is disposed below the belt module BM. The recording sheet S fed from the sheet feed passage SH1 of the sheet feed device U2 is transported to the sheet transport passage SH2 by transport rollers Ra as an example of transport members. The recording sheet S transported to the sheet transport passage SH2 is fed by registration rollers Rr as an example of a feed sections according to a time when the toner image is transported to the secondary transfer region Q4, is guided by sheet guides SG1 and SG2 as an example of medium guide sections, and is transported to the secondary transfer region Q4.

The toner image on the intermediate transfer belt B is transferred onto the recording sheet S by the secondary transfer device T2 when passing through the secondary transfer region Q4. Meanwhile, in a case of a color image, the toner images overlappingly and primarily transferred onto the surface of the intermediate transfer belt B are collectively and secondarily transferred onto the recording sheet S.

The intermediate transfer belt B from which the toner images have been secondarily transferred is cleaned by a belt cleaner CLB as an example of a cleaning section for the intermediate transfer section.

The recording sheet S to which the toner images are secondarily transferred is sent to a medium transport belt BH as an example of a transport member. The medium transport belt BH transports the recording sheet S to a fixing device F that is an example of a belt unit and an example of a fixing section. The fixing device F includes a heating unit Fh as an example of a heating section and a pressure roller Fp as an example of a pressure section. A fixing region Q5 is formed of a region where the heating unit Fh and the pressure roller Fp face each other and are in contact with each other.

The toner images on the recording sheet S are heated and fixed by the fixing device F when passing through the fixing region Q5. The recording sheet S to which the toner images are fixed by the fixing device F is discharged to a discharge tray TRh as an example of a discharge part.

A sheet transport passage SH is formed of reference numerals SH1, SH2, and the like. Further, a sheet transport device SU is formed of reference numerals SH, Ra, Rr, SG1, SG2, BH, and the like.

### Description of Fixing Device

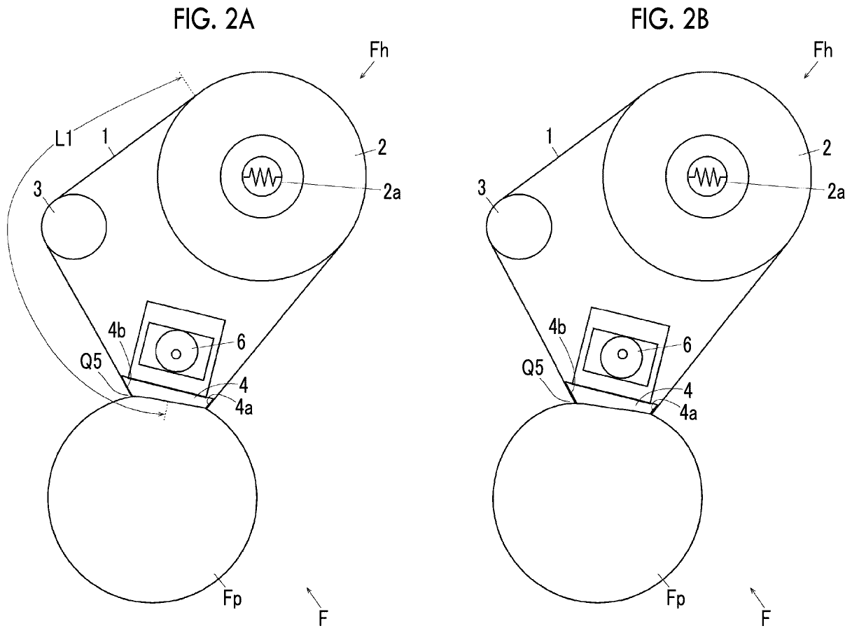

FIGS. 2A and 2B are enlarged views of the fixing device of Example 1 in which FIG. 2A is a diagram showing a state where a support member is moved to a first contact position and FIG. 2B is a diagram showing a state where the support member is moved to a second contact position.

In FIG. 1, the heating unit Fh of the fixing device F of Example 1 includes a fixing belt 1 as an example of an endless member. The fixing belt 1 is stretched by a heating roller 2 as an example of a rotating section, a steering roller 3 as an example of a bias correction section, and a heating pad 4 as an example of a support member.

The fixing belt 1 can be made of any material publicly known in the related art, and it is preferable that a substrate thereof is made of, for example, a polyimide-based material having high stiffness. Further, it is preferable that a surface layer of the fixing belt 1 is made of, for example, a material such as a fluororesin having high releasability of molten toner, paper powder, or the like.

A heater 2a as an example of a heating section is built in the heating roller 2 of Example 1. The heating roller 2 heated by the heater 2a heats the fixing belt 1 that is in contact with the heating roller 2.

The steering roller 3 corrects the meandering or bias of the fixing belt 1.

The heating pad 4 is disposed to face the pressure roller Fp as an example of a counter member. The fixing region Q5 is formed in a region between the fixing belt 1, which is supported by the heating pad 4, and the pressure roller Fp. Therefore, unfixed images on the recording sheet S passing through the fixing region Q5 are fixed to the recording sheet S by being pressed while being heated.

The heating pad 4 of Example 1 is supported to be movable in a direction in which the heating pad 4 approaches or is separated from the pressure roller Fp. The heating pad 4 is moved in a direction in which the heating pad 4 approaches or is separated from the pressure roller Fp as an eccentric cam 6 as an example of an operation section is rotated. The heating pad 4 of Example 1 is movable between a fixing position as an example of the first contact position shown in FIG. 2A and a high-pressure position as an example of the second contact position shown in FIG. 2B. At the fixing position shown in FIG. 2A, the heating pad 4 brings the fixing belt 1 into contact with the pressure roller Fp at a predetermined first contact pressure. At the high-pressure position shown in FIG. 2B, the heating pad 4 is moved to a position closer to a center of the pressure roller Fp than at the fixing position. Therefore, at the high-pressure position, the fixing belt 1 is in contact with the pressure roller Fp at a second contact pressure higher than the first contact pressure.

An aspect in which the heating pad 4 is moved in a direction in which the heating pad 4 approaches or is separated from the pressure roller Fp to switch between the first contact pressure and the second contact pressure has been described in Example 1, but the present invention is not limited thereto. The pressure roller Fp can also be made movable in a direction in which the pressure roller Fp approaches or is separated from the heating pad 4 to switch between the first contact pressure and the second contact pressure. Since the heating pad 4 does not need to be moved in the aspect in which the pressure roller Fp is moved, the posture of the fixing belt 1 is less affected. As a result, the posture of the fixing belt 1 is likely to be stable. On the other hand, since only the heating pad 4 smaller than the pressure roller Fp is moved in the aspect in which the heating pad 4 is moved, a force and a load required to move the heating pad 4 are small.

The heating pad 4 of Example 1 is disposed in a non-rotating state with respect to the fixing belt 1, unlike the heating roller 2 and the steering roller 3.

Further, a downstream end portion 4a and an upstream end portion 4b of the heating pad 4 of Example 1 in a rotation direction of the fixing belt 1 have different shapes. An angle between the upstream end portion 4b and a sheet transport direction is set to be smaller than an angle between the downstream end portion 4a and the sheet transport direction so that the recording sheet S is guided to the fixing region Q5. An angle between the downstream end portion 4a and the sheet transport direction is set to be large so that releasability between the recording sheet S having passed through the fixing region Q5 and the fixing belt 1 is improved. The fixing belt 1 is supported in a posture in which a portion of the fixing belt 1 corresponding to the downstream end portion 4a is bent. In other words, a curvature radius of the portion of the fixing belt 1 corresponding to the downstream end portion 4a is smaller than a curvature radius of a portion of the fixing belt 1 corresponding to the upstream end portion 4b. Therefore, the posture of the fixing belt 1 is changed at a sharp angle at the downstream end portion 4a.

Further, the heating pad 4 of Example 1 is disposed at a position separate from the heating roller 2 that heats the fixing belt 1.

### Description of Controller of Example 1

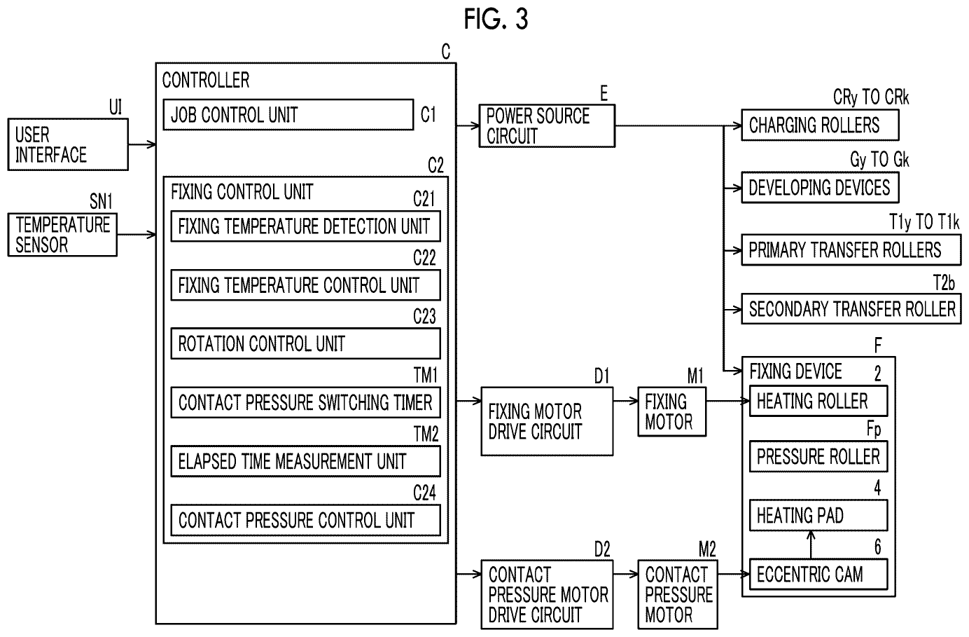

FIG. 3 is a functional block diagram of a controller of Example 1.

In FIG. 3, the controller C of the copying machine U includes an input/output interface I/O that inputs and outputs signals to and from the outside. Further, the controller C includes a read-only memory (ROM) in which a program, information, and the like used for necessary processing are stored. Furthermore, the controller C includes a random access memory (RAM) that temporarily stores necessary data. In addition, the controller C includes a central processing unit (CPU) that performs processing corresponding to the program stored in the ROM or the like. Accordingly, the controller C of Example 1 is formed of a small information processing device (a so-called microcomputer). Therefore, the controller C can realize various functions by executing the program stored in the ROM or the like.

Signals from a signal output element are input to the controller C of Example 1 and the controller C outputs signals to control target elements to control the control target elements.

### Description of Signal Output Element

Signals from signal output elements such as the user interface UI, a temperature sensor SN1 as an example of a temperature detection unit, and other sensors (not shown) are input to the controller C.

The user interface UI inputs contents, which are input by a user or a worker, to the controller C.

The temperature sensor SN1 detects the temperature of the fixing belt 1 and outputs a detection result thereof to the controller C.

### Description of Control Target Elements

The controller C outputs signals to the power source circuit E, a fixing motor drive circuit D1, a contact pressure motor drive circuit D2, and other control target elements (not shown).

The power source circuit E controls charging biases of charging rollers CRy to CRk, developing biases of the developing devices Gy to Gk, primary transfer biases of the primary transfer rollers T1y to T1k, a secondary transfer bias of the secondary transfer roller T2b, the supply of power to the heater of the fixing device F, and the like.

The fixing motor drive circuit D1 controls a fixing motor M1 to rotate the pressure roller Fp, and the fixing belt 1 is rotated.

The contact pressure motor drive circuit D2 controls a contact pressure motor M2 to operate the eccentric cam 6 and to move the heating pad 4.

### Functions of Controller C

The controller C of Example 1 includes the following functional sections (functional modules, program modules).

A job control unit C1 controls a job that is an image forming operation. In a case where the job is started, the job control unit C1 controls the photoreceptor drums Py to Pk, the power source circuit E, and the like to form an image on the recording sheet S.

A fixing control unit C2 includes a fixing temperature detection unit C21, a fixing temperature control unit C22, a rotation control unit C23, a contact pressure switching timer TM1, an elapsed time measurement unit TM2, and a contact pressure control unit C24. The fixing control unit C2 controls the operation and stop of the fixing device F.

The fixing temperature detection unit C21 detects the temperature of the fixing belt 1 on the basis of the detection result of the temperature sensor SN1.

The fixing temperature control unit C22 controls ON/OFF of the heater 2a on the basis of a detection result of the fixing temperature detection unit C21 to maintain the temperature of the fixing belt 1 at a predetermined fixing temperature. The fixing temperature control unit C22 starts to control the heater 2a such that the temperature of the fixing belt 1 reaches a fixing temperature in a case where the job is started.

The rotation control unit C23 controls the fixing motor M1 to control the rotation of the pressure roller Fp. The rotation of the fixing belt 1 to be rotated is also indirectly controlled as the rotation of the pressure roller Fp is controlled. The rotation control unit C23 of Example 1 drives the fixing motor M1 in a case where the job is started, and stops the fixing motor M1 in a case where the job ends. The fixing motor M1 is driven or stopped even in predetermined cases such the time of power-on and the time of maintenance in addition to the time of the start of the job. The rotation control unit C23 of Example 1 controls the rotation speed of the fixing belt 1 in a period in which a contact pressure in the fixing region Q5 is controlled to the second contact pressure to a rotation speed lower than a rotation speed in a period in which the contact pressure in the fixing region Q5 is controlled to the first contact pressure. In other words, in the period in which the contact pressure in the fixing region Q5 is controlled to the first contact pressure, the fixing belt 1 is rotated at a rotation speed for fixing and performs the fixing of an image to the recording sheet S passing through the fixing device. On the other hand, since the fixing of an image to the recording sheet S is not performed in the period in which the contact pressure in the fixing region Q5 is controlled to the second contact pressure, the fixing belt 1 is controlled to be rotated at a low rotation speed. It is preferable that the fixing belt 1 is rotated, for example, at a low rotation speed in the period in which the contact pressure in the fixing region Q5 is controlled to the second contact pressure, but the fixing belt 1 may be rotated at a rotation speed identical to the rotation speed in the period in which the contact pressure in the fixing region Q5 is controlled to the first contact pressure.

The contact pressure switching timer TM1 measures a time when the contact pressure in the fixing region Q5 is switched from the second contact pressure to the first contact pressure. In Example 1, a time when the fixing belt 1 is rotated once (goes around once) after the start of the rotation of the fixing belt 1 is set as a time to switch the contact pressure. In Example 1, the first recording sheet S fed is set not to reach the fixing region Q5 even though the fixing belt 1 goes around once from the start of the job. That is, a time before the first recording sheet S reaches the fixing region Q5 is set as the time to switch the contact pressure.

The elapsed time measurement unit TM2 measures an elapsed time from the stop of the rotation of the fixing belt 1.

The contact pressure control unit C24 controls a contact pressure between the fixing belt 1 and the pressure roller Fp. The contact pressure control unit C24 of Example 1 operates the eccentric cam 6 via the contact pressure motor M2 to move the heating pad 4 between the fixing position and the high-pressure position. The contact pressure control unit C24 moves the heating pad 4 to the high-pressure position in a case where the job is started and the fixing belt 1 starts to rotate. That is, the contact pressure in the fixing region Q5 is changed to the second contact pressure that is a high pressure. Then, in a case where the contact pressure switching timer TM1 determines that it is a time to switch the contact pressure, the contact pressure control unit C24 moves the heating pad 4 from the high-pressure position to the fixing position. Therefore, the contact pressure in the fixing region Q5 is changed to the first contact pressure for fixing. The recording sheet S passes through the fixing region Q5 having the first contact pressure and is heated and an image is fixed to the recording sheet S.

In Example 1, the contact pressure control unit C24 controls the contact pressure between the first contact pressure and the second contact pressure not only at the time of the start of the job but also at the time of power-on. That is, in a case where a trial operation at the time of power-on, that is, a so-called warm-up operation or an initialization operation is performed, the contact pressure is controlled even though the fixing belt 1 is rotated. Therefore, the contact pressure control unit C24 controls the contact pressure to the second contact pressure in a case where the fixing belt 1 starts to rotate at the time of power-on, and switches the contact pressure to the first contract pressure in a case where it is the time to switch the contact pressure.

Further, the control of the contact pressure is adapted to be performed each time at the start of the job in Example 1, but the present invention is not limited thereto. For example, in a case where the elapsed time measured by the elapsed time measurement unit TM2 reaches a predetermined first time, the contact pressure can also be controlled to the second contact pressure when the fixing belt 1 starts to rotate. That is, it is also possible to rotate the fixing belt 1 while maintaining the first contact pressure for fixing without changing the contact pressure to the second contact pressure that is a high pressure in a case where an elapsed time from the end of a previous job is a short time (less than the first time), and to change the contact pressure to the second contact pressure that is a high pressure in a case where the elapsed time from the end of the previous job is a long time (equal to or longer than the first time). Therefore, it is possible to suppress unnecessary operations and the wear of members by maintaining the first contact pressure in a case where the contact pressure does not need to be changed to the second contact pressure. The first time can be set to, for example, 5 minutes, but can be appropriately changed according to design, specifications, and the like.

In addition, in a case where the temperature of the fixing belt 1 at the time of the start of the job is lower than a predetermined first temperature, it is also possible to control the contact pressure to the second contact pressure. That is, in a case where the elapsed time from the end of the previous job is long and the temperature of the fixing belt 1 is lower than the first temperature, a control of changing the contact pressure to the second contact pressure that is a high pressure is performed. On the other hand, in a case where the elapsed time from the end of the previous job is short and the temperature of the fixing belt 1 is not much lower than the fixing temperature, the contact pressure is not changed to the second contact pressure that is a high pressure and the fixing belt 1 is rotated while the first contact pressure for fixing is maintained. Therefore, it is possible to suppress unnecessary operations and the wear of members by maintaining the first contact pressure in a case where the contact pressure does not need to be changed to the second contact pressure. The first temperature can be set to, for example, a temperature of 80% of the fixing temperature, but can be appropriately changed according to design, specifications, and the like.

### Action of Example 1

In the copying machine U of Example 1 having the above-described configuration, in a case where the image forming operation (job) is started, the image is transferred onto the recording sheet S in the secondary transfer region Q4 and the recording sheet S is sent to the fixing region Q5. In the fixing device F, the fixing belt 1 is heated and the developers on the surface of the recording sheet S are heated, melted, and fixed when the recording sheet S passes through the fixing region Q5. After the job ends, the fixing belt 1 is naturally cooled without being heated and the temperature of the fixing belt 1 is lowered. The fixing belt 1 of which the temperature has been lowered is likely to have high hardness. Therefore, in a case where the fixing belt 1 is held for a long time in a posture in which the fixing belt 1 is supported by the heating roller 2, the steering roller 3, and the heating pad 4, the fixing belt 1 is likely to have a tendency to be bent or a pattern. In a case where the fixing belt 1 has a tendency to be bent or a pattern, the rotational resistance of the fixing belt 1 in a case where the fixing belt 1 starts to rotate is increased. In particular, since the heating pad 4 is in a non-rotating state with respect to the fixing belt 1 in Example 1, the rotational resistance of the fixing belt 1 is likely to increase. Further, since the fixing belt 1 is in a posture in which the fixing belt 1 is bent at the downstream end portion 4a of the heating pad 4 of Example 1, the fixing belt 1 is likely to have a tendency to be bent or the like. For this reason, the rotational resistance of the fixing belt 1 is likely to increase as compared to a case where the shape of the downstream end portion 4a is gentle.

As a result, in a case where the fixing belt 1 is rotated by the pressure roller Fp, the surface of the fixing belt 1 is likely to slide (is likely to slip) on the pressure roller Fp. In a case where the slip occurs, damage such as scratches may occur on the surface of the fixing belt 1. In a case where the fixing belt 1 is damaged, image quality may deteriorate due to poor fixing or the like or the life of a product may be shortened. In a configuration in which the grip members are provided as disclosed in JP2001-075385A, the grip members function at all times including not only a time when measures against slip are required but also during normal rotation. Accordingly, there is a problem that the grip members cause rotational resistance or the grip members are also worn out quickly. Therefore, a high-capacity motor considering the rotational resistance is required or the frequency of replacement of the fixing device including the grip members is increased. For this reason, there is a problem that the overall cost is increased.

In contrast, in Example 1, the contact pressure between the fixing belt 1 and the pressure roller Fp is controlled to the second contact pressure that is a high pressure in a case where the rotation of the fixing belt 1 is started. Accordingly, slip at the time of the start of the rotation of the fixing belt 1 is suppressed as compared to a case where the rotation of the fixing belt 1 is started while the first contact pressure is maintained. Therefore, damage such as scratches on the fixing belt 1 is suppressed.

In Example 1, the fixing belt 1 is rotated at a low speed in the period in which the contact pressure is controlled to the second contact pressure. Therefore, the occurrence of slip is suppressed as compared to a case where the fixing belt 1 is not rotated at a low speed.

In particular, in the fixing device F of Example 1, the heating pad 4 is not rotated or the fixing belt 1 is held in the posture in which the portion of the fixing belt 1 corresponding to the downstream end portion 4a is bent. Accordingly, rotational resistance is likely to increase. In contrast, since the fixing belt 1 starts to rotate at the second contact pressure in Example 1, the slip is likely to be suppressed.

Further, in Example 1, the heater 2a is disposed at a position separate from the fixing region Q5. In a fixing device in which the heater is built in the heating pad facing the fixing region Q5, for example, it is also conceivable to suppress rotational resistance by warming up the heater before the start of the rotation of the fixing belt 1 to reduce the hardness of the fixing belt 1 in the fixing region Q5. However, in Example 1, the heater 2a is disposed in the heating roller 2 disposed at a position separate from the fixing region Q5. Further, the fixing belt 1 is heated as the heating roller 2 is rotated. In the fixing device F of Example 1, in a case where the fixing belt 1 is to be warmed before the start of the rotation of the fixing belt 1, it is necessary to wait for the fixing belt 1 to be warmed by thermal conduction. In this case, there is a problem that it takes time to complete the heating of the fixing belt 1. In contrast, in Example 1, the fixing belt 1 is rotated at the second contact pressure without waiting for the fixing belt 1 to be warmed. Therefore, in Example 1, slip and scratches are suppressed while an activation time is shortened.

In Example 1, when the fixing belt 1 has been rotated once after the rotation of the fixing belt 1 is started, the contact pressure is switched from the second contact pressure to the first contact pressure. That is, in a case where the fixing belt 1 is warmed by the heating roller 2 and the hardness of the fixing belt 1 is reduced, so that slip is less likely to occur, the contact pressure is switched to the first contact pressure for fixing. Before the fixing belt 1 is rotated once, the recording sheet S does not reach the fixing region Q5. Accordingly, the recording sheet S reaches the fixing region Q5 after the contact pressure is switched to the first contact pressure, and the image is fixed under predetermined fixing conditions (the fixing temperature and a fixing pressure (first contact pressure)).

Further, in Example 1, the contact pressure is controlled to the second contact pressure not only at the time of the start of the job but also at a time when the rotation of the fixing belt 1 is started at the time of power-on. Accordingly, damage to the fixing belt 1, which is caused by slip during a trial operation at the time of power-on, is suppressed.

### Modification Examples

The example of the present invention has been described in detail above, but the present invention is not limited to the example described above and can have various modifications without departing from the scope of the present invention described in claims. Modification examples (H01) to (H07) of the present invention will be exemplified below.

(H01) The copying machine U as an example of the image forming apparatus has been exemplified in the example described above, but the present invention is not limited thereto. For example, the image forming apparatus can also be formed of FAX, a printer, and a multifunction machine.

(H02) A configuration in which developers for four colors are used has been exemplified as the image forming apparatus in the example described above, but the present invention is not limited thereto. For example, the present invention can also be applied to a monochromatic image forming apparatus, and an image forming apparatus for multiple colors of three colors or less or five colors or more.

(H03) A time when the fixing belt 1 is rotated once has been exemplified as the time to switch the contact pressure in the example described above, but the present invention is not limited thereto. A time less than the time when the fixing belt 1 is rotated once can also be set as the time to switch the contact pressure. For example, a period until a surface portion of the fixing belt 1 having been in contact with the heating roller 2 at the time of the start of the rotation of the fixing belt 1 reaches the fixing region Q5 can also be set as the time to switch the contact pressure. That is, an elapsed time when a distance by which the fixing belt 1 is rotated corresponds to a distance L1 shown in FIG. 2A can be set as the time to switch the contact pressure. In addition, a time when the fixing temperature reaches a predetermined temperature can also be set as the time to switch the contact pressure. Moreover, a time when the fixing belt 1 is rotated two or more times can also be set as the time to switch the contact pressure according to design, specifications, and the like. However, in Example 1, the time to switch the contact pressure is set to a time when the fed recording sheet S does not reach the fixing device F yet after the start of the job.

(H04) For example, it is desired that the heating pad 4 is not rotated in the example described above, but a roller-shaped member or a belt-shaped member that can also be rotated can be used as the heating pad 4. Further, the shape of the downstream end portion 4a of the heating pad 4 and the shape of the upstream end portion 4b are also not limited to the shapes exemplified in the example. The downstream end portion 4a can also have a shape identical to the shape of the upstream end portion 4b. Conversely, the upstream end portion 4b can also have a shape identical to the shape of the downstream end portion 4a.

(H05) An aspect in which the heater 2a as a heating section is built in the heating roller 2 has been exemplified in the example described above, but the present invention is not limited thereto. The heater 2a can also be built in the heating pad 4.

(H06) The fixing device F has been exemplified as the belt unit in the example described above, but the present invention is not limited thereto. For example, the image forming apparatus may include belts such as an intermediate transfer belt, a photoreceptor belt, a transfer/transport belt, and a secondary transfer belt, and the present invention can be applied to any belt unit in which a problem of scratches is raised.

(H07) An aspect in which the pressure roller Fp is driven to rotate the fixing belt 1 has been exemplified in the example described above, but the present invention is not limited thereto. The present invention can also be applied to a configuration in which the fixing belt 1 is driven to rotate the pressure roller Fp. The present invention can also be applied to a case where a pressure belt is used instead of the pressure roller Fp.

### Supplementary Note

(((1)))

A belt unit comprising:
an endless member that is rotated;
a support member that supports the endless member;
a counter member that is disposed to face the support member with the endless member interposed therebetween and is in contact with the endless member at a predetermined first contact pressure;
a heating section that heats the endless member; and
a control unit that starts heating in the heating section in a case where rotation of the endless member is started, and controls at least one of the support member or the counter member to control a contact pressure between the endless member and the counter member to a second contact pressure higher than the first contact pressure.
   (((2)))

The belt unit according to (((1))),
wherein the support member supports the endless member and is not rotated.
   (((3)))

The belt unit according to (((2))),
wherein the support member supports the endless member in a posture in which the endless member is bent at a downstream end of the support member in a rotation direction of the endless member.
   (((4)))

The belt unit according to any one of (((1))) to (((3))),
wherein the heating section is disposed at a position separate from the support member.
   (((5)))

The belt unit according to (((4))), further comprising:
a rotating section in which the heating section is built and which supports and rotates the endless member.
   (((6)))

The belt unit according to any one of (((1))) to (((5))),
wherein the control unit returns the contact pressure to the first contact pressure from the second contact pressure after the endless member is rotated once.
   (((7)))

The belt unit according to any one of (((1))) to (((5))),

wherein the control unit controls the contact pressure to the second contact pressure in a period until a surface portion of the endless member having been in contact with the heating section at a time of start of the rotation of the endless member reaches a position facing the counter member.
(((8)))

The belt unit according to any one of (((1))) to (((7)),
wherein the support member is supported to be movable in a direction in which the support member approaches or is separated from the counter member, and
the control unit moves the support member in the direction in which the support member approaches the counter member as compared to a case where the control unit controls the contact pressure to the first contact pressure in a case where the control unit controls the contact pressure to the second contact pressure.
   (((9)))

The belt unit according to any one of (((1))) to (((8))),
wherein the counter member is supported to be movable in a direction in which the counter member approaches or is separated from the support member, and
the control unit moves the counter member in the direction in which the counter member approaches the support member as compared to a case where the control unit controls the contact pressure to the first contact pressure in a case where the control unit controls the contact pressure to the second contact pressure.
   (((10)))

The belt unit according to any one of (((1))) to (((9))), wherein the control unit controls the contact pressure to the second contact pressure at a time when the rotation of the endless member is started at a time of power-on.

(((11)))

The belt unit according to any one of (((1))) to (((10))), further comprising:
a measurement unit that measures an elapsed time from stop of the rotation of the endless member,
wherein the control unit controls the contact pressure to the second contact pressure in a case where the elapsed time measured by the measurement unit reaches a predetermined first time.
   (((12)))

The belt unit according to any one of (((1))) to (((11))), further comprising:
a temperature detection unit that detects a temperature of the endless member,
wherein the control unit controls the contact pressure to the second contact pressure in a case where the temperature detected by the temperature detection unit does not reach a predetermined first temperature.
   (((13)))

The belt unit according to any one of (((1))) to (((12))),
wherein the control unit controls a rotation speed of the endless member in a period in which the contact pressure is controlled to the second contact pressure to a rotation speed lower than a rotation speed in a period in which the contact pressure is controlled to the first contact pressure.
   (((14)))

The belt unit according to any one of (((1))) to (((13))),
wherein the belt unit is formed of a fixing device that fixes an unfixed image on a surface of a medium with heat of the heating section and the contact pressure between the endless member and the counter member when the medium passes between the endless member and the counter member.
   (((15)))

An image forming apparatus comprising:
an image holding member that holds an image on a surface of the image holding member;
a transfer section that transfers the image held on the image holding member onto a medium; and
the belt unit according to (((14))) that fixes the image transferred onto the medium.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A belt unit comprising:
an endless member that is rotated;
a support member that supports the endless member;
a counter member that is disposed to face the support member with the endless member interposed therebetween and is in contact with the endless member at a predetermined first contact pressure;
a heating section that heats the endless member; and
a control unit that starts heating in the heating section in a case where rotation of the endless member is started, and controls at least one of the support member or the counter member to control a contact pressure between the endless member and the counter member to a second contact pressure higher than the first contact pressure.

2. The belt unit according to claim 1,
wherein the support member supports the endless member and is not rotated.

3. The belt unit according to claim 2,
wherein the support member supports the endless member in a posture in which the endless member is bent at a downstream end of the support member in a rotation direction of the endless member.

4. The belt unit according to claim 1,
wherein the heating section is disposed at a position separate from the support member.

5. The belt unit according to claim 4, further comprising:
a rotating section in which the heating section is built and which supports and rotates the endless member.

6. The belt unit according to claim 1,
wherein the control unit returns the contact pressure to the first contact pressure from the second contact pressure after the endless member is rotated once.

7. The belt unit according to claim 1,
wherein the control unit controls the contact pressure to the second contact pressure in a period until a surface portion of the endless member having been in contact with the heating section at a time of start of the rotation of the endless member reaches a position facing the counter member.

8. The belt unit according to claim 1,
wherein the support member is supported to be movable in a direction in which the support member approaches or is separated from the counter member, and
the control unit moves the support member in the direction in which the support member approaches the counter member as compared to a case where the control unit controls the contact pressure to the first contact pressure in a case where the control unit controls the contact pressure to the second contact pressure.

9. The belt unit according to claim 1,
wherein the counter member is supported to be movable in a direction in which the counter member approaches or is separated from the support member, and
the control unit moves the counter member in the direction in which the counter member approaches the support member as compared to a case where the control unit controls the contact pressure to the first contact pressure in a case where the control unit controls the contact pressure to the second contact pressure.

10. The belt unit according to claim 1,
wherein the control unit controls the contact pressure to the second contact pressure at a time when the rotation of the endless member is started at a time of power-on.

11. The belt unit according to claim 1, further comprising:
a measurement unit that measures an elapsed time from stop of the rotation of the endless member,
wherein the control unit controls the contact pressure to the second contact pressure in a case where the elapsed time measured by the measurement unit reaches a predetermined first time.

12. The belt unit according to claim 1, further comprising:
a temperature detection unit that detects a temperature of the endless member,
wherein the control unit controls the contact pressure to the second contact pressure in a case where the temperature detected by the temperature detection unit does not reach a predetermined first temperature.

13. The belt unit according to claim 1,
wherein the control unit controls a rotation speed of the endless member in a period in which the contact pressure is controlled to the second contact pressure to a rotation speed lower than a rotation speed in a period in which the contact pressure is controlled to the first contact pressure.

14. The belt unit according to claim 1,
wherein the belt unit is formed of a fixing device that fixes an unfixed image on a surface of a medium with heat of the heating section and the contact pressure between the endless member and the counter member when the medium passes between the endless member and the counter member.

15. The belt unit according to claim 2,
wherein the belt unit is formed of a fixing device that fixes an unfixed image on a surface of a medium with heat of the heating section and the contact pressure between the endless member and the counter member when the medium passes between the endless member and the counter member.

16. The belt unit according to claim 3,
wherein the belt unit is formed of a fixing device that fixes an unfixed image on a surface of a medium with heat of the heating section and the contact pressure between the endless member and the counter member when the medium passes between the endless member and the counter member.

17. The belt unit according to claim 4,
wherein the belt unit is formed of a fixing device that fixes an unfixed image on a surface of a medium with heat of the heating section and the contact pressure between the endless member and the counter member when the medium passes between the endless member and the counter member.

18. The belt unit according to claim 5,
wherein the belt unit is formed of a fixing device that fixes an unfixed image on a surface of a medium with heat of the heating section and the contact pressure between the endless member and the counter member when the medium passes between the endless member and the counter member.

19. The belt unit according to claim 6,
wherein the belt unit is formed of a fixing device that fixes an unfixed image on a surface of a medium with heat of the heating section and the contact pressure between the endless member and the counter member when the medium passes between the endless member and the counter member.

20. An image forming apparatus comprising:
an image holding member that holds an image on a surface of the image holding member;
a transfer section that transfers the image held on the image holding member onto a medium; and
the belt unit according to claim 14 that fixes the image transferred onto the medium.
